(19) United States
(12) Patent Application Publication
(10) Pub. No.: US 2015/0161253 A1
(43) Pub. Date: Jun. 11, 2015

(54) CONTEXTUAL DISPLAY APPARATUS AND METHODS

(71) Applicant: INTEL CORPORATION, SANTA CLARA, CA (US)

(72) Inventors: Shibani Kapoor Shah, San Jose, CA (US); Marci Meingast, Berkley, CA (US)

(21) Appl. No.: 14/128,485

(22) PCT Filed: Jun. 24, 2013
(86) PCT No.: PCT/US2013/047288

§ 371 Date: Dec. 20, 2013

(51) Int. Cl. G06F 17/30; G06F 17/22; H04L 29/06

(52) U.S. Cl. CPC G06F 17/30861; H04L 63/08; G06F 17/2247

(57) ABSTRACT

Embodiments of apparatus and methods for contextual display are described. In embodiments, an apparatus for contextual display may include a processor, a communication module, and a contextual display module. The contextual display module may be configured to retrieve contextual information of a user having permission to view a file, and select a device among multiple devices associated with the user to display the file based at least in part on the contextual information of the user. The communication module may be configured to receive and send the file to the user. Other embodiments may be described and/or claimed.

### FIELD OF THE INVENTION

The present disclosure relates generally to data processing apparatuses and methods, and more particularly, apparatuses and methods for contextual display.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

Global Internet protocol (IP) traffic has been increasing rapidly. It is forecasted to reach an annual volume of two-thirds of a zettabyte by 2013. Video is estimated to take up ninety percent of consumer IP traffic, while mobile video will commensurably consume more than sixty percent of total mobile IP traffic. Multimedia content proliferates in social sharing sites because, indeed, a picture is worth a thousand words. Meanwhile, ample choices of diverse consumer electronic devices in modern life may continue to make multimedia content accessible in a place and time at demand.

However, the full potential of viewing experience of Internet users may have not yet been fully developed. As an example, users typically would not able to view multimedia content directed to them instantly, rather they would be required to perform at least the action of logging on to a website or service first. As another example, the delivery of multimedia content is generally ignorant of the ample choices of heterogeneous electronic devices a user may have. For instance, comparing to a smart TV, a smartphone may not be able to offer superior viewing experience for playing a video clip due to its limited screen or bandwidth. Yet as another example, the delivery of multimedia content may lack of awareness of user preferences. A user may prefer not to display any personal multimedia content in her office, but the same content would be welcomed in home.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example contextual display network, incorporating aspects of the present disclosure, in accordance with various embodiments.

FIG. 2 is a block diagram illustrating an example apparatus incorporating aspects of the present disclosure, in accordance with various embodiments.

FIG. 3 is a flow diagram of an example contextual display process which may be practiced by an example apparatus, incorporating aspects of the present disclosure, in accordance with various embodiments.

FIG. 4 is a flow diagram of an example device selection process which may be practiced by an example apparatus, incorporating aspects of the present disclosure, in accordance with various embodiments.

FIG. 5 is a flow diagram of an example display switch process which may be practiced by an example apparatus, incorporating aspects of the present disclosure, in accordance with various embodiments.

FIG. 6 illustrates an example computing device suitable for practicing the disclosed embodiments, in accordance with various embodiments.

FIG. 7 illustrates an article of manufacture having programming instructions, incorporating aspects of the present disclosure, in accordance with various embodiments.

### DETAILED DESCRIPTION

Embodiments of apparatus and methods for contextual display are described herein. In embodiments, an apparatus for contextual display may include one processor, a communication module, and a contextual display module. The contextual display module may be configured to retrieve contextual information of a user having permission to view a file, e.g., a photo, and select a device, e.g., a smartphone, among multiple devices associated with the user to display the file based at least in part on the contextual information of the user. Additionally, the communication module may be configured to receive the file and forward the file to a user device. These and other aspects will be more fully described below.

In the following detailed description, reference is made to the accompanying drawings, which form a part hereof, wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The description may use the phrases “in one embodiment,” “in an embodiment,” “in another embodiment,” “in embodiments,” “in various embodiments,” or the like, which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

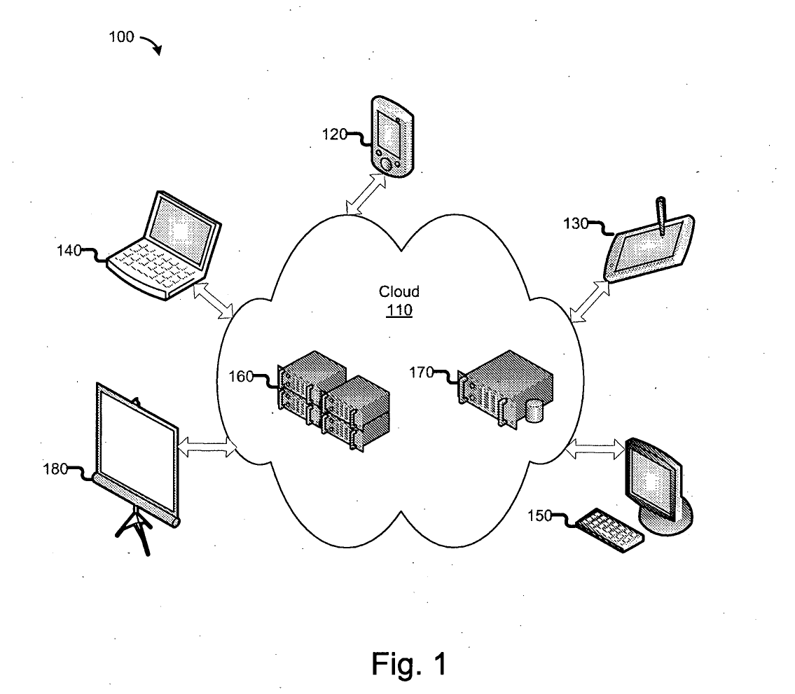

Referring now to FIG. 1, an example contextual display system 100, in accordance with various embodiments, is illustrated. Contextual display system (CDS) 100 may include multiple service devices, such as servers 160 and 170, and user devices, such as devices 120, 130, 140, 150 and 180. As will be described in more detail below, service devices and user devices may be incorporated with the teachings of the present disclosure to provide contextual display for users. Resultantly, user viewing experience may be enhanced.

In embodiments, user devices in CDS 100 may include heterogeneous computing devices, such as, but not limited to, smartphone 120, tablet computer 130, laptop computer 140, desktop computer 150, and smart TV 180, incorporated with the teachings of the present disclosure. While not illustrated, user devices in CDS 100 may also include a handheld computer, a cellular phone, a pager, an audio and/or video player (e.g., an MP3 player, a digital photo frame, a DVD player, a home theatre system, etc.), a gaming device, a video camera, a digital camera, a navigation device (e.g., a GPS device), a wireless peripheral (e.g., a printer, a scanner, a headset, etc.), an appliance (e.g., a refrigerator, a microwave oven, a washer, etc.), and/or other suitable fixed, portable, or mobile electronic devices, enhanced with the teachings of the present disclosure.

In embodiments, user devices in CDS 100 may be configured to communicate with a computing infrastructure complex, or cloud 110. In embodiments, cloud 110 may include one or more service devices, for example, servers 160 and/or data servers 170, incorporated with the teachings of the present disclosure, to cooperatively provide contextual display service. In embodiments, servers 160 may be application servers, sometimes also referred to as middleware, which may perform application related logic of contextual display service between users and database servers 170. In embodiments, data servers 170 may be dedicated to provide database services for contextual display service, and other computer programs or computers so that data may be queried, managed, stored, and retrieved from a storage.

In embodiments, user devices in CDS 100 may be configured to communicate with each other in a peer to peer mode, and incorporate the functions of service devices, e.g., servers 160 and data servers 170, in one or more user devices. As an example, service functions of CDS 100 may be dynamically relocated to desktop computer 150, and desktop computer 150 may be enabled to perform contextual display functions to other user devices, such as tablet computer 130.

Cloud 110 may support cloud computing which generally refers to an adequately resourced computing model with resources, such as hardware, storage, management solutions, security solutions, business applications, etc. available as services via networking. Cloud 110 may generally offer its services as infrastructure as a service (IaaS), platform as a service (PaaS), software as a service (SaaS), network as a service (NaaS), and communication as a service (CaaS). Moreover, cloud 110 may specifically offer contextual display services based on one or more service types, such as IaaS, PaaS, SaaS, NaaS, or CaaS. In embodiments, contextual display services may be provided by servers 160 in cooperation with data servers 170, hereinafter, collectively referred to as “contextual display server.” Furthermore, contextual display services may be made available on demand and to be delivered economically.

In embodiments, CDS 100 may be configured to interface with any online service, such as online social networks. For example, many smart TV platforms come prepackaged, or can be optionally extended, with social networking technology capabilities. Thus CDS 100 may seamlessly deliver multimedia content from social networks to a smart TV while providing a cinematic viewing experience when the smart TV is accessible to the targeted users.

In embodiments, CDS 100 may be configured to serve multiple devices associated with a user via one or more communication modules. CDS 100 may be configured to register or associate the multiple devices with the user, for example, based on the user's email address, identification, or any suitable credential. CDS 100 may receive a file, e.g., a multimedia file, permissible to be viewed by a user. Instead of directly sending the file to the user's email address, CDS 100 may retrieve contextual information of the user, and intelligently select one device among multiple devices associated with the user based on the contextual information of the user to display the file immediately. Moreover, the file may be stored and managed, for example, by data server 170 in connection with server 160, in the cloud 110.

User devices may be wireless devices and thus may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate with cloud 110 via wireless links.

In embodiments, some user devices, e.g., smartphone 120, may operate in accordance with suitable wireless communication protocols that require very low power such as Bluetooth, ultra-wide band (UWB), and/or radio frequency identification (RFID) to implement wireless personal area network (WPAN). In embodiments, some user devices, e.g., tablet 130, may use direct sequence spread spectrum (DSSS) modulation and/or frequency hopping spread spectrum (FHSS) modulation to implement a wireless local area network (WLAN) (e.g., the 802.11 family of standards developed by the Institute of Electrical and Electronic Engineers (IEEE) and/or variations and evolutions of these standards).

In embodiments, some user devices, e.g., laptop computer 140, may use OFDM modulation to transmit large amounts of digital data by splitting a radio frequency signal into multiple small sub-signals, which in turn, are transmitted simultaneously at different frequencies. Although some of the above examples are described with respect to standards developed by IEEE, the present disclosure is readily applicable to many specifications and/or standards developed by other special interest groups and/or standard development organizations (e.g., Wireless Fidelity (Wi-Fi) Alliance, Worldwide Interoperability for Microwave Access (WiMAX) Forum, Infrared Data Association (IrDA), or Third Generation Partnership Project (3GPP), etc.).

In embodiments, cloud 110 may include one or more wireless and/or wired networks operatively couple the user devices to servers 160 and 170. The networks may include public and/or private networks, such as, but not limited to, the Internet, a telephone network (e.g., public switched telephone network (PSTN)), a local area network (LAN), a wide area network (WAN), a cable network, an Ethernet network, a digital subscriber line (DSL), and so forth. In embodiments, user devices may be coupled to these networks via a telephone line, a coaxial cable, and/or a wireless connection. Wireless communication networks may include various combinations of WPANs, WLANs, wireless metropolitan area networks (WMANs), and/or wireless wide area networks (WWANs).

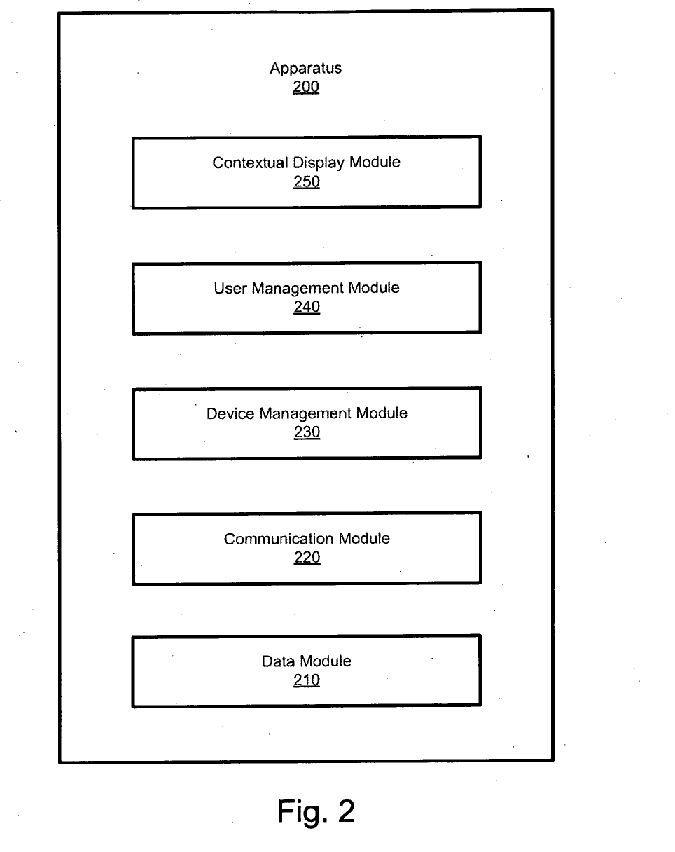

Referring now to FIG. 2, an example apparatus 200 is illustrated in further detail, in accordance with various embodiments. In embodiments, apparatus 200 may be a server device or a user device discussed above with reference to FIG. 1. Apparatus 200 may include data module 210, communication module 220, device management module 230, user management module 240, and contextual display module 250, selectively coupled with each other. Moreover, the components of apparatus 200, discussed in detail below, may be included in any one or more of the service or user devices discussed above with reference to FIG. 1, including servers 160, data servers 170, smartphone 120, tablet computer 130, laptop computer 140, etc.

In embodiments, data module 210 may be configured to store, retrieve, query, and manipulate data stored via, e.g. data servers 170 with reference to FIG. 1. Communication module 220 may be configured to receive and transmit data from and to cloud 110 or any one of the devices discussed above with reference to FIG. 1. Communication module 220 may use numerous networking hardware and/or interfaces, e.g. modems, network interface controllers (NICs), wireless network interface controller (WNTC), to enable apparatus 200's communication with computers on the same LAN and/or computers on a remote network through routable protocols, such as internet protocols (IPs). In some embodiments, communication module 220 may operate in accordance with suitable wireless communication protocols that require very low power such as Bluetooth, ultra-wide band (UWB), and/or radio frequency identification (RFID) to implement wireless personal area network (WPAN). In some other embodiments, communication module 220 may also enable communication via visible light, infrared, sonic, or other communication modes besides radio-based communication. In embodiments, data received via communication module 220 may be stored via data module 210.

In embodiments, device management module 230 may be configured to manage user devices including any one of the user devices discussed above with reference to FIG. 1. Multiple user devices associated with a user may be registered with CDS 100 through a registration process. As an example, the registration process may be accomplished automatically by installing on a user device a contextual display application, which may be configured to authenticate the user and/or register the user device. As another example, the registration process may be accomplished manually if the user chooses to provide a hardware identification of the device, such as media access control (MAC) address to CDS 100. Yet as another example, a common identification, such as an email address of the user, may be used to bind multiple devices used by the user in CDS 100 so that any device with the common identification may access CDS 100.

In embodiments, device management module 230 may be configured to collect properties of user devices and store them via data module 210. Properties of a user device may include hardware, software, and networking attributes. Hardware properties may include properties of the physical parts of a computing device, such as display (e.g. type of display, screen size, resolution, response time), CPU (graphic cards, sound cards, memory, motherboard and chips), keyboard, data storage, hard drive disk, mouse, printers, etc. Software properties may include properties of system software (e.g., operating system, such as Android®, BSD®, iOS®, Linux®, Mac OS X®, Microsoft Windows®, or IBM z/OS®), application software (e.g., media play application, codec), or embedded software (e.g., firmware). Networking properties may include the network type (e.g., Ethernet, WiFi, cellular network, etc.), speed (e.g., upload and download speed, delay, etc.), service type (e.g., unlimited, data plan, pay as go, etc.). In embodiments, device management module 230 may be configured to monitor the state of user devices, such as whether a user device is online or offline, busy or idle etc.

In embodiments, user management module 240 may be configured to collect contextual information of users and store such information via data module 210. Contextual information of users may include user's general preferences for displaying multimedia files or other types of files. As an example, a user may prefer to playback audio files via her smartphone but to playback video files via her computer. As another example, a user may prefer to display files sent by her client immediately on any user device she may have access at the moment, but prefer to display files shared via a social network only via a smart TV in home. Yet as another example, a user may want to conserve mobile data due to a limited data plan from her mobile carrier, and prefer to switch displaying of large files from her smartphone to her home computer whenever she returns home. Yet as another example, a user may prefer to display a particular type of files, such as private messages, only if she is alone.

Contextual information of users may include properties of user devices. In embodiments, not every user devices accessible to a user is capable to display all types of files. As an example, some video files may be coded in a specific format which may only be decoded within a specific operating system. As another example, the carrier of a mobile device may intentionally restrict the effective bandwidth of the mobile device for displaying certain files, such as streamed online videos. Such bandwidth throttling may be used in an attempt to regulate network traffic and minimize bandwidth congestion.

Contextual information of a user may also include location information of the user, ambient information of the user, activity information of the user, or social network information of the user. In embodiments, such contextual information may be collected from the user, such as from the user's online calendar or online activities. In embodiments, such contextual information may be retrieved from user devices. As an example, the location information of a user may be inferred from the geographical position of her mobile device. As another example, ambient and activity information of the user may be retrieved in real time via the visual or audial input of her devices. Yet as another example, social network information of the user may be collected from the user's social network profiles and history.

In embodiments, device management module 230 may be configured to provide information of a user device to contextual display module 250, including device properties and the current state of the device. In embodiments, user management module 240 may be configured to provide contextual information of a user to contextual display module 250. In embodiments, the functionalities of user management module 240 and/or device management module 230 may be implemented directly by contextual display module 250.

In embodiments, in response to receiving or discovering a file permissible to be viewed by a user or the user having permission to view a file, contextual display module 250 may be configured to retrieve contextual information of the user, and select one device among multiple devices associated with the user to display the file based at least in part on the contextual information of the user. In embodiments, contextual display module 250 may be configured to interface with the user's email programs, messaging programs, or other communication programs or services, and intercept multimedia files or other types of files sent to the user. In embodiments, contextual display module 250 may be configured to actively seek multimedia files or other types of files from one or more designated information sources, such as news services or social networks based on the user's preferences.

In response to the discovery of such file permissible to be viewed by the user, contextual display module 250 may be configured to retrieve contextual information of the user. In embodiments, based at least in part on the properties of the file, properties of each user device, or the contextual information of the user, contextual display module 250 may be configured to select one among many user devices to display the file. In embodiments, based at least in part on the contextual information of the user, contextual display module 250 may be configured to send the user a notification of the file via a selected user device instead of directly display the file. As an example, when the user is among a group of users or engrossed in an intense activity, the user may prefer to only get the notification.

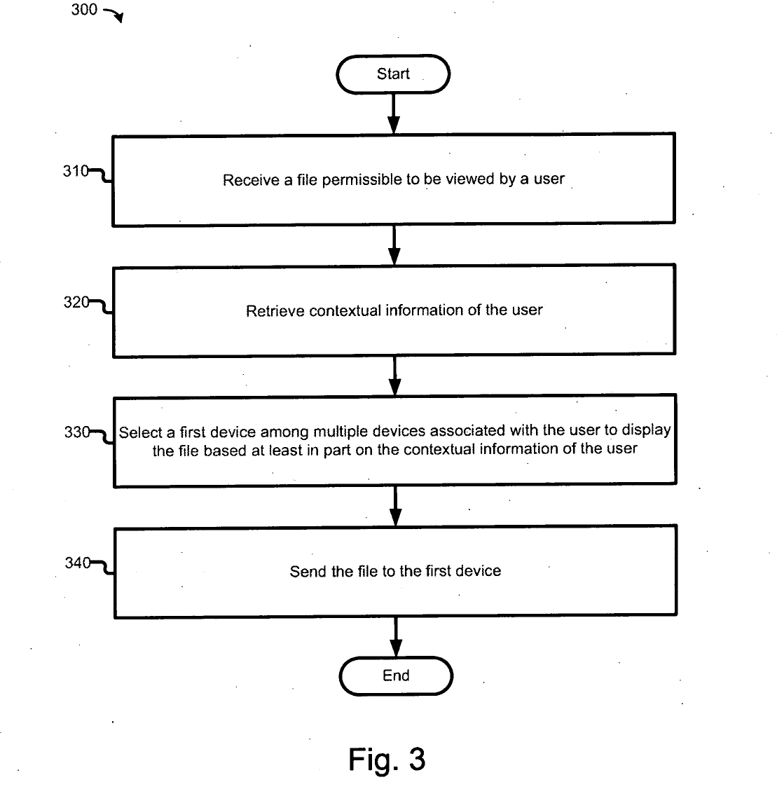

Referring now to FIG. 3, it is a flow diagram of an example contextual display process which may be practiced by an example apparatus, incorporating aspects of the present disclosure, in accordance with various embodiments. As shown, process 300 may be performed by apparatus 200 to implement one or more embodiments of the present disclosure. In embodiments, the process may begin at block 310, where a file permissible to be viewed by a user may be discovered or received, e.g., by contextual display module 250 via communication module 220. In some embodiments, the permission to view a file may be readily ascertainable. As an example, a user may gain permission to a file if it was addressed to the user, such as attached in an email to the user. In some embodiments, the permission to view a file may be inferred. As an example, friends of a user in her online social network may be inferred to have the permission to view a file posted by the user in the online social network. In some embodiments, the permission to view a file may be explicitly designated by the source of the file. As an example, the organizer of a seminar may designate the recordings of the seminar to be viewed only by attendees of the seminar or all subscribers of the organizer's services. In some embodiments, the permission to view a file may be automatically granted. As an example, contextual display module 250 may search public contents on the Web based on a user's preference, and automatically grant viewing permission to the user for any findings.

Next, at block 320, contextual information of the user may be retrieved, e.g., by contextual display module 250 and/or user management module 240 as illustrated in reference to FIG. 1. In embodiments, contextual display module 250 may retrieve many types of contextual information, including information already stored relating to the user and the user's devices and information dynamically learned about the current state of the user.

Next, at block 330, at least one device among multiple devices associated with the user may be selected, e.g., by contextual display module 250, to display the file based at least in part on the contextual information of the user. In embodiments, the selection may be based at least in part on the user's preferences. As an example, the user may prefer to view a video file with the largest display screen among all accessible electronic devices. Thus, contextual display module 250 may compare all electronic devices accessible to the user at the moment and select a winner accordingly. In embodiments, the selection may be based at least in part on the properties of the user device. As an example, if the carrier of the user's smartphone regularly conducts bandwidth throttling for playing streamed video files, contextual display module 250 may avoid to select video files to this smartphone and seek for alternative devices for streamed video files.

In embodiments, the selection may be based at least in part on the location information of the user. As an example, although a user may carry together a smartphone and a tablet, contextual display module 250 may select the user's smartphone while the user is walking down the street due to the convenience of the device, but select the user's tablet while the user is waiting at the airport due to the superior viewing experience on the tablet. In embodiments, the selection may be based at least in part on the ambient information of the user. As an example, although a smart TV would provide the potential best viewing experience in a home, contextual display module 250 may select the user's smartphone instead because other viewers before the smart TV may not have the permission to view the file sent to the user. In embodiments, the selection may be based at least in part on the activity information of the user. As an example, although a user may carry together a smartphone and a laptop during a conference, but contextual display module 250 may only send a notification of a newly arrived file to the user's smartphone in order to mitigate any disturbance. In embodiments, the selection may be based at least in part on the social network information of the user. As an example, contextual display module 250 may send files received from the user's coworkers to the user's working computer, but send files received from the user's family to the user's personal computer. In embodiments, the selection may be based on any combinations of any parameters of the contextual information of the user.

Next, at block 340, the file may be sent or caused to be sent to the selected device, e.g., by contextual display module 250 via communication module 220. In embodiments, the file may be sent via any communication mode, any communication network, or any communication technology as illustrated in connection with FIG. 1. In embodiments, contextual display module 250 may cause the file to be delivered to the selected device by a remote service when the file is stored remotely, e.g., in a content delivery network.

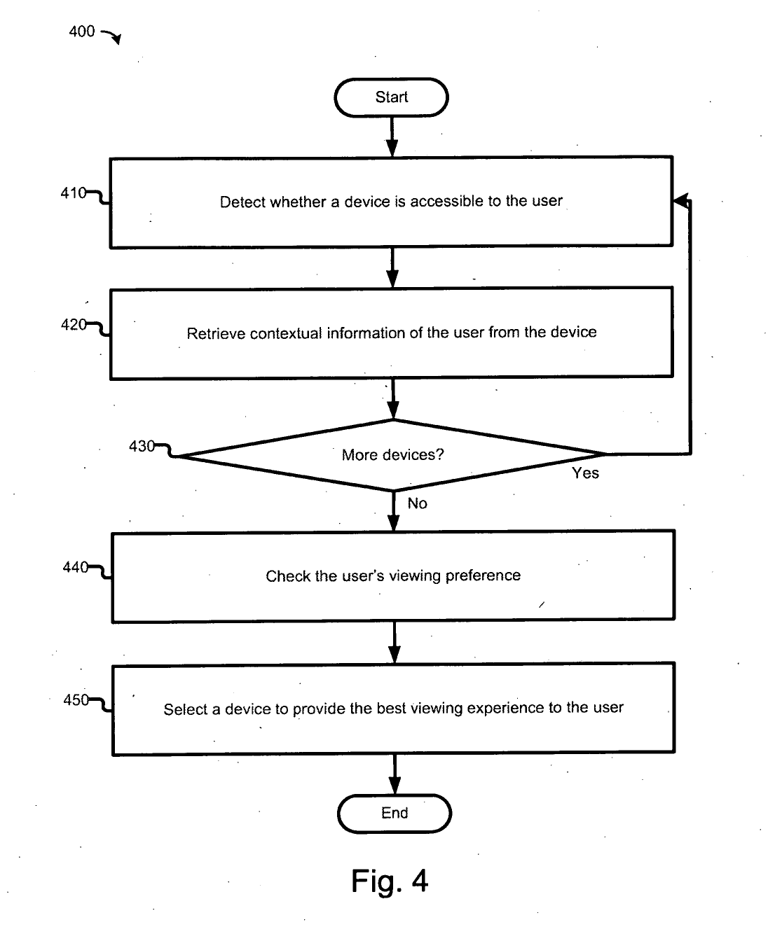

Referring now to FIG. 4, it is a flow diagram of an example device selection process which may be practiced by an example apparatus, incorporating aspects of the present disclosure, in accordance with various embodiments. As shown, process 400 may be performed by apparatus 200 to implement one or more embodiments of the present disclosure. In embodiments, process 400 may be performed in reference to blocks 320 and 330 in FIG. 3.

In embodiments, the process may begin at block 410, where the accessibility of a device to the user is detected, e.g., by contextual display module 250. In embodiments, accessibility may refer to the fact a device being readily available to the user. As an example, smartphone 120 may be placed in the vicinity of the user, and thus is readily available to the user. As another example, laptop computer 140 may be turned off, thus become inaccessible to display a file to the user at the moment. In embodiments, accessibility may refer to the fact a device being actively used by the user. As an example, desktop computer 150 may be registered by multiple users sharing the computer. However, desktop computer 150 may only accessible to the user actively using it.

In embodiments, contextual display module 250 may be configured to determine whether a particular user device is accessible to the user based on, such as user input via an input device, networking activities, or system status of the device. In embodiments, contextual display module 250 may also be configured to use information collected via motion sensors (e.g., infrared) or proximity sensors (e.g., near field communication (NFC), Bluetooth) provided by user devices to determine accessibility or contextual information of the user. In embodiments, contextual display module 250 may also be configured to use information collected via imaging and/or audio recording functions provided by user devices to determine accessibility and/or contextual information of the user. For example, a user device may be deemed accessible to the user if the user is recognized via the recorded image or audio samples.

In embodiments, a user device may have a camera which may be used to record images or videos. In embodiments, the user device may be configured for face/image recognition that is to identify a face or an object by comparing features of the captured image with facial features of a user or some identifying reference features. In embodiments, the recorded images or videos may be transmitted to contextual display module 250 for face/image recognition.

In embodiments, a user device may have an audio recorder that records and plays back audio, including articulated voice. In embodiments, the audio recorder may be sound-activated that may be automatically actuated upon detection of sound above a predetermined threshold. In embodiments, the audio recorder may be configured for speech recognition that is to recognize and/or transcribe what is being said. The acoustic features of speech that recorded from the surrounding of the device may be used to compare with the voice biometrics or audio profile registered with the user. An audio profile may include features such as those acoustic patterns reflecting anatomy (e.g., size and shape of the throat and mouth) and learned behavioral patterns (e.g., voice pitch, speaking style) of a user. In embodiments, the audio recorder may be configured for speaker/voice recognition that is to identify the speaker by characteristics of their voice biometrics. In embodiments, recorded audio clips may be transmitted to contextual display module 250 for speaker/voice recognition or transcribing.

Next, at block 420, contextual information of the user may be retrieved, e.g., by contextual display module 250, from the user device or via user management module 240 and device management module 230. In embodiments, location based services enabled by user devices may provide location related contextual information. As an example, based on trilateration, a use device connected with a WiFi network may able to determine indoor location of the device, thus the user, such as a conference room, the user's office, the lobby, etc.

In embodiments, a visual/audio recording of the surrounding of the user device may be used to provide contextual information, such as location information of the user, ambient information of the user, activity information of the user. As an example, a landmark or some identifying reference feature may be recognized in the recorded image, and thus the location of the user who carries the device may be learned. As another example, ambient or activity information of the user may be directly or indirectly learned from the visual/audio recordings, such as whether the user is alone or with a group and what type of activity the user is engaged at the moment.

Next, at block 430, a decision may be made for whether there are more devices to be inquired. If there are more user devices need to be queried, process 400 may return to block 410, otherwise, process 400 may enter into block 440. In embodiments, contextual display module 250 may be configured to query multiple user devices sequentially, randomly, or in a predetermined order. In embodiments, contextual display module 250 may use a short list of all devices associated with the user without exhaustively query all of them. Such short list may be determined dynamically, e.g., based on the properties of the file on hand.

Next, at block 440, viewing preferences of the user may be checked, e.g., by contextual display module 250 via user management module 240. In embodiments, viewing preferences may be considered as a part of the contextual information of the user. As an example, viewing preferences may be related to the ambient information of the user, such as whether other users near the user are permitted to view the file. As illustrated early, visual or audio recordings of the surrounding of the user may be used to provide ambient information of the user. In embodiments, face recognition may be performed on other users. Contextual display module 250 may be configured to further inquire the known social networks of the user, the preferences of the user, the permission setting of the file, etc., thus to determine whether other users are also permitted to view the file. In embodiments, contextual display module 250 may send a file to a user device only if all users near the user device have permission to view the file. Otherwise, contextual display module 250 may only send a notification of the file to the user or continue to seek alternative user devices to display the file.

In embodiments, a notification of the file may be in any form set by the user. As an example, the notification could be in the form of a vibration, a sound, or light flashing on the closest user device to the user. In embodiments, the notification mechanism may provide the user an additional layer of security and privacy that contextual display module 250 or the user may have overlooked. For example, the user could be deeply engrossed in watching a movie and not want to be disturbed. In this case, the notification may subtly remind the user of the waiting file without disrupting the user's viewing pleasure.

Next at block 450, a device may be selected to provide the best viewing experience to the user by, e.g., contextual display module 250. In embodiments, multiple devices may be suitable to display the file. Contextual display module 250 may be configured to choose one device that may offer the user the potential best viewing experience for the file at hand based on the contextual information. For example, if the file is a high resolution movie, and both a photo frame and a smart TV are suitable to display the movie in the user's living room, contextual display module 250 may choose the smart TV as it is has a larger display area to show the high resolution movie.

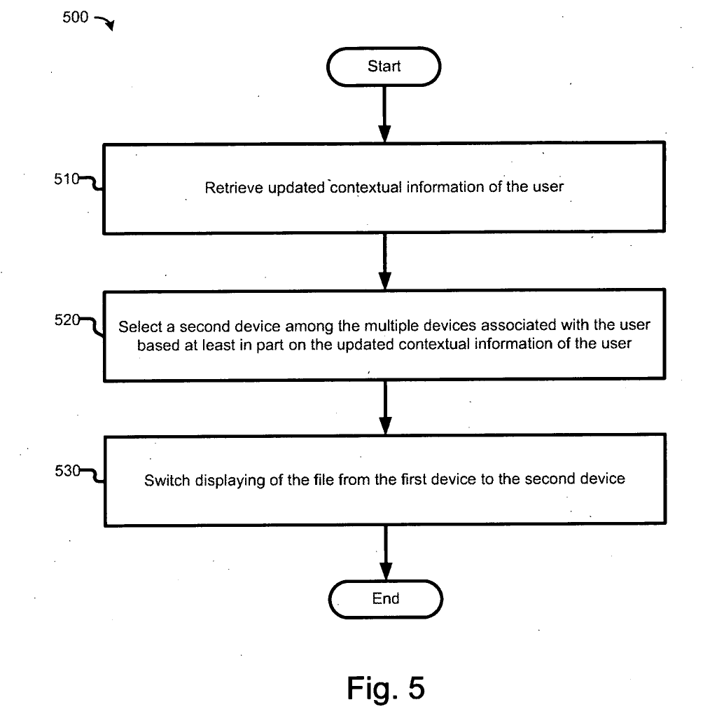

Referring now to FIG. 5, it is a flow diagram of an example display switch process which may be practiced by an example apparatus, incorporating aspects of the present disclosure, in accordance with various embodiments. As shown, process 500 may be performed by apparatus 200 to implement one or more embodiments of the present disclosure.

In embodiments, the process may begin at block 510, where updated contextual information of the user may be retrieved, e.g., by contextual display module 250. In embodiments, contextual display module 250 may be configured to continuously or periodically retrieve contextual information of the user. As an example, contextual display module 250 may initially send a file to a wearable computer with a head-mounted display (HMD). The wearable computer may report to contextual display module 250 that the user has returned to her living room and turned on her smart TV. As another example, the first device may encounter severe network congestions in streaming the file, and such contextual information update may be directly detected by contextual display module 250 if the file is streamed from communication module 220.

Next, at block 520, a second device among the multiple devices′associated with the user may be selected, e.g., by the contextual display module 250, to switch displaying of the file from the first device to the second device, based at least in part on the updated contextual information of the user. In embodiments, contextual display module 250 may be prompted to take adaptive actions when the contextual information of the user has been substantially changed. Continuing with the previous examples, contextual display module 250 may select the smart TV as the second device in order to offer the user a better viewing experience in the first example, or seek an alternative displaying device to manager audio/video jitters in the second example.

Next, at block 530, displaying of the file may be switched from the first device to the second device. In embodiments, contextual display module 250 may keep on tracking the status of the file during its displaying, and seamlessly switch the displaying from one device to the other. As an example, all appliances in a user's home may be capable of displaying videos. While the user moves from kitchen to laundry room to do domestic chores, the video played on her refrigerator may be switched to her washer so that the viewing experience of the user would not be interrupted by the domestic chores.

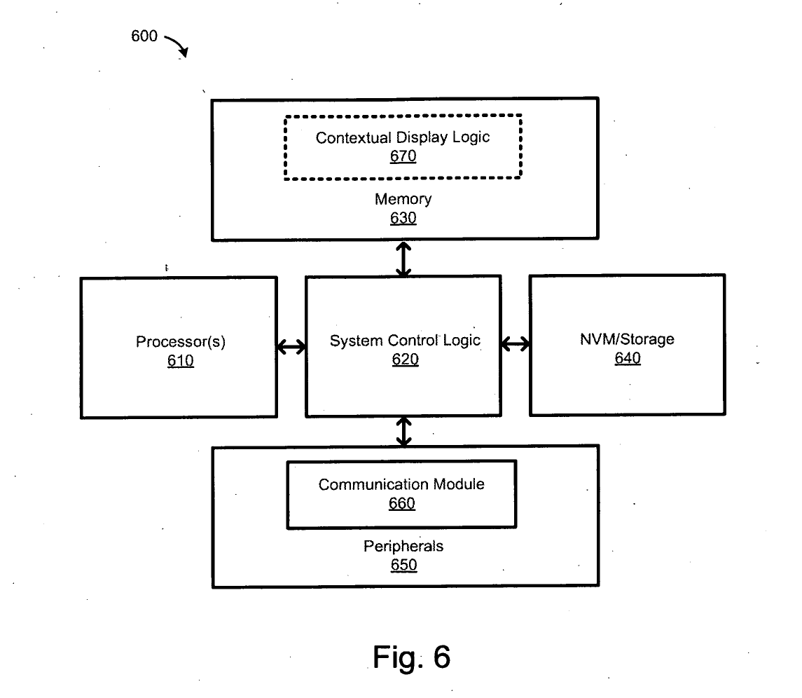

FIG. 6 illustrates an embodiment of a computing device 600 suitable for practicing embodiments of the present disclosure. As illustrated, computing device 600 may include system control logic 620 coupled to one or more processor(s) 610, to system memory 630, to non-volatile memory (NVM)/storage 640, and to one or more peripherals 650. In various embodiments, the one or more processors 610 may include a processor core. In embodiments, peripherals 650 may also include one or more communication modules, such as communication module 660, similar to earlier described communication module 220 in connection with FIG. 2.

In some embodiments, system control logic 620 may include any suitable interface controllers to provide for any suitable interface to the processor(s) 610 and/or to any suitable device or component in communication with system control logic 620. System control logic 620 may also interoperate with a display (not shown) for display of information, such as to a user. In various embodiments, the display may include one of various display formats and forms, such as, for example, liquid-crystal displays, cathode-ray tube displays, and e-ink displays. In various embodiments, the display may include a touch screen.

In some embodiments, system control logic 620 may include one or more memory controller(s) (not shown) to provide an interface to system memory 630. System memory 630 may be used to load and store data and/or instructions, for example, for computing device 600. System memory 630 may include any suitable volatile memory, such as suitable dynamic random access memory (DRAM), for example.

In some embodiments, system control logic 620 may include one or more input/output (I/O) controller(s) (not shown) to provide an interface to NVM/storage 640 and peripherals 650. NVM/storage 640 may be used to store data and/or instructions, for example. NVM/storage 640 may include any suitable non-volatile memory, such as flash memory, for example, and/or may include any suitable non-volatile storage device(s), such as one or more hard disk drive(s) (HDD), one or more solid-state drive(s), one or more compact disc (CD) drive(s), and/or one or more digital versatile disc (DVD) drive(s), for example. NVM/storage 640 may include a storage resource that is physically part of a device on which computing device 600 is installed or it may be accessible by, but not necessarily a part of, computing device 600. For example, NVM/storage 640 may be accessed by computing device 600 over a network via one or more communication modules within peripherals 650.

In embodiments, system memory 630, NVM/storage 640, and system control logic 620 may include, in particular, temporal and persistent copies of contextual display logic 670. The contextual display logic 670 may include instructions that, when executed by at least one of the processor(s) 610, result in computing device 600 practicing one or more aspects of contextual display services, such as, but not limited to, processes 300, 400, and 500, as well as other operations performed by device management module 230, user management module 240 and/or contextual display module 250, described above.

Communication module 660 within peripherals 650 may provide an interface for computing device 600 to communicate over one or more network(s) and/or with any other suitable device. Communications module 660 may include any suitable hardware and/or firmware, such as a network adapter, one or more antennas, wireless interface(s), and so forth. In various embodiments, communication module 660 may include an interface for computing device 600 to use NFC, optical communications (e.g., barcodes), or other similar technologies to communicate directly (e.g., without an intermediary) with another device. In various embodiments, communication module 660 may interoperate with radio communications technologies such as, for example, WCDMA, GSM, LTE, Bluetooth, Zigbee, and the like.

Depending on which modules of apparatus 200 (FIG. 2) are hosted by computing device 600, the capabilities and/or performance characteristics of processors 610, memory 630, and so forth, may vary. In various implementations, computing device 600 may be a laptop, a netbook, a notebook, an subnotebook, an Ultrabook™, a smartphone, a tablet, a personal digital assistant, an ultra mobile PC, a mobile phone, a desktop computer, a server, a printer, a scanner, a monitor, a set-top box, an entertainment control unit (e.g., a gaming console), a digital camera, a digital music player, or a digital video recorder. Additionally, other devices in the above-described interactions may be configured to perform various disclosed techniques.

In some embodiments, at least one of the processor(s) 610 may be packaged together with system control logic 620 and/or contextual display logic 670. In some embodiments, at least one of the processor(s) 610 may be packaged together with system control logic 620 and/or contextual display logic 670 to form a System in Package (SiP). In some embodiments, at least one of the processor(s) 610 may be integrated on the same die with system control logic 620 and/or contextual display logic 670. In some embodiments, at least one of the processor(s) 610 may be integrated on the same die with system control logic 620 and/or contextual display logic 670 to form a System on Chip (SoC).

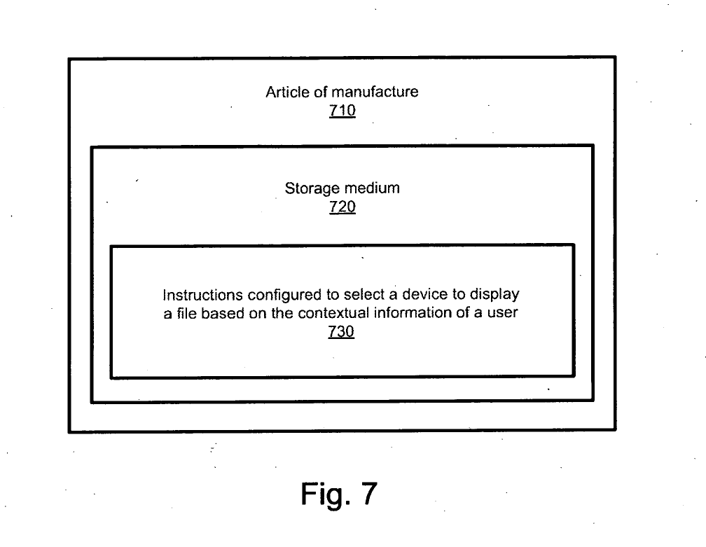

FIG. 7 illustrates an article of manufacture 710 having programming instructions, incorporating aspects of the present disclosure, in accordance with various embodiments. In various embodiments, an article of manufacture may be employed to implement various embodiments of the present disclosure. As shown, the article of manufacture 710 may include a computer-readable non-transitory storage medium 720 where instructions configured to implement contextual display 730 reside. The storage medium 720 may represent a broad range of persistent storage medium known in the art, including but not limited to flash memory, dynamic random access memory, static random access memory, an optical disk, a magnetic disk, etc. Instructions 730 may enable an apparatus, in response to their execution by the apparatus, to perform various operations described herein. For example, storage medium 720 may include instructions 730 configured to cause an apparatus or system to practice some or all aspects of contextual display of the process 300 of FIG. 3, process 400 of FIG. 4, or process 500 of FIG. 5, in accordance with embodiments of the present disclosure.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

The following paragraphs describe examples of various embodiments.

Example 1 is an method for contextual display which may include retrieving, by a computing device, contextual information of a user having permission to view a file; selecting, by the computing device, a first device among a plurality of devices associated with the user to display the file, based at least in part on the contextual information of the user; and sending or causing to be sent, by the computing device, the file to the first device.

Example 2 may include the subject matter of Example 1, and may further include determining, by the computing device, whether one or more other users near the user are permitted to view the file.

Example 3 may include the subject matter of Examples 1-2, and further include sending a notification of the file, by the computing device to the user.

Example 4 may include the subject matter of Examples 1-3, and further include detecting whether the first device is accessible to the user.

Example 5 may include the subject matter of Example 4, and further specifics that the detection is based at least in part on an image of a surrounding area of the first device.

Example 6 may include the subject matter of Example 5, and further specifies that the detection is based at least in part on a comparison of a face captured in the image with the user, or a feature captured in the image with an identifying reference feature.

Example 7 may include the subject matter of Example 4-6, and further specifies that the detection is based at least in part on an ambient audio recording of the device.

Example 8 may include the subject matter of Example 7, and further specifics that the detection is based at least in part on a match of the ambient audio recording with a voice profile of the user.

Example 9 may include the subject matter of Examples 1-8, and further include selecting a second device among the plurality of devices associated with the user based at least in part on updated contextual information of the user, and switching displaying of the file from the first device to the second device.

Example 10 may include the subject matter of Examples 1-9, and further specifies that the contextual information comprises display preferences of the user, properties of user devices, location information of the user, ambient information of the user, activity information of the user, or social network information of the user.

Example 11 is a storage medium having stored therein instructions configured to cause a device, in response to execution of the instructions by the device, to practice any one of the methods of 1-10. The storage medium may be non-transient.

Example 12 is an apparatus for contextual display which may include means to practice any one of the method of 1-10.

Example 13 is an apparatus for contextual display which may include one or more processors; a communication module; and a contextual display module, coupled with the communication module, and configured to be operated by the one or more processors to retrieve contextual information of a user having permission to view a file, and select a first device among a plurality of devices associated with the user to display the file based at least in part on the contextual information of the user.

Example 14 may include the subject matter of Example 13, and may further include a device management module, coupled with the contextual display module, and configured to manage device information of the plurality of devices associated with the user; a user management module, coupled with the contextual display module, and configured to manage information of users; and a data module, coupled with the communication module, the device management module, the user management module, and the contextual display module, and configured to be operated by the one or more processors to store the file, the device information, and the contextual information.

Example 15 may include the subject matter of Examples 13-14, and further specifies that the contextual display module is further configured to determine whether one or more other users near the user are permitted to view the file.

Example 16 may include the subject matter of Examples 13-15, and further specifies that the contextual display module is further configured to send a notification of the file to the user.

Example 17 may include the subject matter of Examples 13-16, and further specifies that the contextual display module is further configured to detect whether the first device is accessible to the user.

Example 18 may include the subject matter of Example 17, and further specifies that the detection is based at least in part on an image of a surrounding area of the first device.

Example 19 may include the subject matter of Example 18, and further specifies that the detection is based at least in part on a comparison of a face captured in the image with the user, or a feature captured in the image with an identifying reference feature.

Example 20 may include the subject matter of Examples 17-19, and further specifies that the detection is based at least in part on an ambient audio recording of the device.

Example 21 may include the subject matter of Example 20, and further specifies that the detection is based at least in part on a match of the ambient audio recording with a voice profile of the user.

Example 22 may include the subject matter of Examples 13-21, and further specifies that the contextual information comprises display preferences of the user, properties of user devices, location information of the user, ambient information of the user, activity information of the user, or social network information of the user.

Example 23 may include the subject matter of Examples 13-22, and further specifies that the contextual display module is further configured to select a second device among the plurality of devices associated with the user based at least in part on updated contextual information of the user, and to switch displaying of the file from the first device to the second device.

Example 24 may include the subject matter of Examples 13-23, wherein the communication module may be configured to be operated by the one or more processors to receive and send the file permissible to the user.

1-24. (canceled)

25. At least one non-transitory storage medium comprising a plurality of instructions configured to cause a computing device, in response to execution of the instructions by the computing device, to:
retrieve, by the computing device, contextual information of a user with permission to view a file;
select, by the computing device, a first device among a plurality of devices associated with the user to display the file, based at least in part on the contextual information of the user; and
send or cause to be sent, by the computing device, the file to the first device.

26. The storage medium of claim 25, the instructions configured to further cause the computing device to:
determine, by the computing device, whether one or more other users near the user are permitted to view the file.

27. The storage medium of claim 25, the instructions configured to further cause the computing device to:
send a notification of the file, by the computing device, to the user.

28. The storage medium of claim 25, the instructions configured to further cause the computing device to:
detect, by the computing device, whether the first device is accessible to the user.

29. The storage medium of claim 28, wherein the detection is based at least in part on an image of a surrounding area of the first device.

30. The storage medium of claim 29, wherein the detection is based at least in part on a comparison of a face captured in the image with the user, or a feature captured in the image with an identifying reference feature.

31. The storage medium of claim 28, wherein the detection is based at least in part on an ambient audio recording of the device.

32. The storage medium of claim 31, wherein the detection is based at least in part on a match of the ambient audio recording with a voice profile of the user.

33. The storage medium of claim 25, the instructions configured to further cause the computing device to:
select a second device among the plurality of devices associated with the user based at least in part on updated contextual information of the user, and switching displaying of the file from the first device to the second device.

34. The storage medium of claim 25, wherein the contextual information comprises display preferences of the user, properties of user devices, location information of the user, ambient information of the user, activity information of the user, or social network information of the user.

35. An apparatus, comprising:
one or more processors;
a communication module; and
a contextual display module, coupled with the communication module, and configured to be operated by the one or more processors to retrieve contextual information of a user having permission to view a file, and select a first device among a plurality of devices associated with the user to display the file based at least in part on the contextual information of the user.

36. The apparatus according to claim 35, further comprising:
a device management module, coupled with the contextual display module, and configured to manage device information of the plurality of devices associated with the user;
a user management module, coupled with the contextual display module, and configured to manage information of users; and
a data module, coupled with the communication module, the device management module, the user management module, and the contextual display module, and configured to be operated by the one or more processors to store the file, the device information, and the contextual information.

37. The apparatus according to claim 35, wherein the contextual display module is further configured to determine whether one or more other users near the user are permitted to view the file.

38. The apparatus according to claim 35, wherein the contextual display module is further configured to send a notification of the file to the user.

39. The apparatus according to claim 35, wherein the contextual display module is further configured to detect whether the first device is accessible to the user.

40. The apparatus according to claim 39, wherein the detection is based at least in part on an image of a surrounding area of the first device.

41. The apparatus according to claim 40, wherein the detection is based at least in part on a comparison of a face captured in the image with the user, or a feature captured in the image with an identifying reference feature.

42. The apparatus according to claim 39, wherein the detection is based at least in part on an ambient audio recording of the device.

43. The apparatus according to claim 42, wherein the detection is based at least in part on a match of the ambient audio recording with a voice profile of the user.

44. The apparatus according to claim 35, wherein the contextual display module is further configured to select a second device among the plurality of devices associated with the user based at least in part on updated contextual information of the user, and to switch displaying of the file from the first device to the second device.

45. The apparatus according to claim 35, the communication module is further configured to be operated by the one or more processors to receive and send the file permissible to user.

46. The apparatus according to any one of claim 35, wherein the contextual information comprises display preferences of the user, properties of user devices, location information of the user, ambient information of the user, activity information of the user, or social network information of the user.

47. A method, comprising:
retrieving, by the computing device, contextual information of a user with permission to view a file;
selecting, by the computing device, a first device among a plurality of devices associated with the user to display the file, based at least in part on the contextual information of the user; and
sending or causing to be sent, by the computing device, the file to the first device.

48. The method according to claim 47, further comprising:
selecting a second device among the plurality of devices associated with the user based at least in part on updated contextual information of the user, and switching displaying of the file from the first device to the second device.

49. The method according to claim 47, wherein the contextual information comprises display preferences of the user, properties of user devices, location information of the user, ambient information of the user, activity information of the user, or social network information of the user.
